(19) United States
(12) Patent Application Publication
(10) Pub. No.: US 2004/0090436 A1
(43) Pub. Date: May 13, 2004

(54) Display unit and power-economy controller

(76) Inventor: Hitoshi Kushima, Kawasaki (JP)

Correspondence Address: STAAS & HALSEY LLP, SUITE 700, 1201 NEW YORK AVENUE, N.W., WASHINGTON, DC, 20005, US

(21) Appl. No.: 10/702,653

(22) Filed: Nov. 7, 2003

(30) Foreign Application Priority Data
Nov. 8, 2002 (JP) 2002-325731

(51) Int. Cl. G09G 5/00

(52) U.S. Cl. 345/211

(57) ABSTRACT

In a display unit connected to a computer main frame to perform an image display, the display unit has a display section that performs an image display in accordance with an image signal, a power source supplying section that supplies a power source to the display unit, a power-economy control section that controls a change over between a conducting mode wherein the power source supplying section supplies the power source and a power-economy wherein the power source supplying section stops a supply of the power source, in accordance with synchronizing signals included in the image signal, and a condenser section that stores electric power of the synchronizing signals and makes the power-economy control section to return to a conductive state.

### BACKGROUND OF THE INVENTION

1. Field of the Invention

The present invention relates to a display unit connected to a computer main frame to perform an image display and a power-economy controller.

2. Description of the Related Art

Hitherto, in a display unit connected to a computer main frame to perform an image display, there is made fit for practical use a display unit contributing to energy saving in such a way that in the event that a computer is not used after the lapse of a predetermined time since a power source of the display unit turns on, the display unit changes over in an operating mode to a power-economy mode in which a dissipation power is little.

As the conventional display unit, there is introduced an example in which a photo-coupler or a relay is driven in accordance with a synchronizing signal transmitted from a computer main frame so that an energy saving change over determination device stops a power supplying circuit (cf. for example, Japanese Patent Application Laid Open Gazette TokuKai Hei. 7-219687, pages 6-7, FIG. 1).

Further, there is introduced an example in which existence of a synchronizing signal transmitted from a computer main frame is detected so that a supplying voltage to a power supply primary smoothing circuit is stopped (cf. for example, Japanese Patent Application Laid Open Gazette TokuKai Hei. 8-289168, pages 5-6, FIG. 2).

However, in case of TokuKai Hei. 7-219687, even in the power-economy mode, it is needed to monitor a return signal to a conducting mode from a computer main frame. Thus, the energy saving change over determination device requires an electric power to keep the monitoring operation even in the power-economy mode. Accordingly, the dissipation power is not zero.

Also in case of TokuKai Hei. 8-289168, it requires an electric power to keep an operation of a circuit for detecting existence of the synchronizing signal even in the power-economy mode.

Thus, the conventional energy saving type of display unit and power-economy controller need control means using a microcomputer and the like to perform a return operation to the conducting mode through detection of the return signal from the computer main frame. For this reason, according to the conventional energy saving type of display unit and power-economy controller, it is usual to dissipate an electric power of 5W to 3W or so even in the power-economy mode. And from the viewpoint of the recent conservation of the environment and protection of a natural resource, such a tendency that the dissipation power at the time of the power-economy mode is further reduced is increased internationally.

### SUMMARY OF THE INVENTION

In view of the foregoing, it is an object of the present invention to provide a display unit in which the dissipation power at the time of the power-economy mode is further reduced, and also to provide a power-economy controller.

To achieve the above-mentioned object, the present invention provides a display unit comprising:

a display section that performs an image display in accordance with an image signal;

a power source supplying section that supplies a power source to the display unit;

a power-economy control section that controls a change over between a conducting mode wherein the power source supplying section supplies the power source and a power-economy wherein the power source supplying section stops a supply of the power source, in accordance with synchronizing signals included in the image signal; and

a condenser section that stores electric power of the synchronizing signals and makes the power-economy control section to return to a conductive state.

According to the display unit according to the present invention as mentioned above, the condenser section that stores electric power of the synchronizing signals and makes the power-economy control section to return to a conductive state. This feature makes it possible to turn off the power-economy control section per se too inclusive, in the power-economy mode. Thus, it is possible that the dissipation power of the display unit is zero.

In the display unit according to the present invention as mentioned above, it is preferable that the power-economy control section stops storage of electric power of the synchronizing signals by the condenser section when the power-economy control section returns to the conductive state.

This feature makes it possible to use the synchronizing signals for the original use of the image display, since charging in the condenser section, which is unnecessary in the conductive state, is intercepted.

To achieve the above-mentioned object, the present invention provides a power-economy controller used in a display unit having a display section that performs an image display in accordance with an image signal, and a power source supplying section that supplies a power source, the power-economy controller comprising:

a power-economy control section that controls a change over of an operating state of the power source supplying section in accordance with synchronizing signals included in the image signal; and

a condenser section that stores electric power of the synchronizing signals and makes the power-economy control section to return to a conductive state.

According to the power-economy controller of the present invention as mentioned above, the condenser section that stores electric power of the synchronizing signals and makes the power-economy control section to return to a conductive state. This feature makes it possible to turn off the power-economy control section per se too inclusive, in the power-economy mode. Thus, it is possible that the dissipation power of the display unit is zero.

In the power-economy controller according to the present invention as mentioned above, it is preferable that the power-economy control section stops storage of electric power of the synchronizing signals by the condenser section when the power-economy control section returns to the conductive state.

This feature makes it possible to use the synchronizing signals for the original use of the image display, since charging in the condenser section, which is unnecessary in the conductive state, is intercepted.

### BRIEF DESCRIPTION OF THE DRAWINGS

FIG. 1 is a schematic illustration of a computer system in which a display unit according to an embodiment of the present invention is connected.

FIG. 2 is a schematic construction view of a display unit according to an embodiment of the present invention.

FIG. 3 is a circuit diagram of a power supplying circuit of a display unit according to an embodiment of the present invention.

FIG. 4 is an explanatory view useful for understanding a state of a display unit according to an embodiment of the present invention at the time of a conducting mode.

FIG. 5 is an explanatory view useful for understanding a state of a display unit according to an embodiment of the present invention after the display unit changes over in operation from a conducting mode to a power-economy mode.

FIG. 6 is an explanatory view useful for understanding an operation of the respective sections of a display unit according to an embodiment of the present invention when the display unit returns from the power-economy mode to the conducting mode.

FIG. 7 is a schematic construction view of a power-economy controller according to an embodiment of the present invention.

### DETAILED DESCRIPTION OF PREFERRED EMBODIMENTS

Embodiments of the present invention will be described with reference to the accompanying drawings.

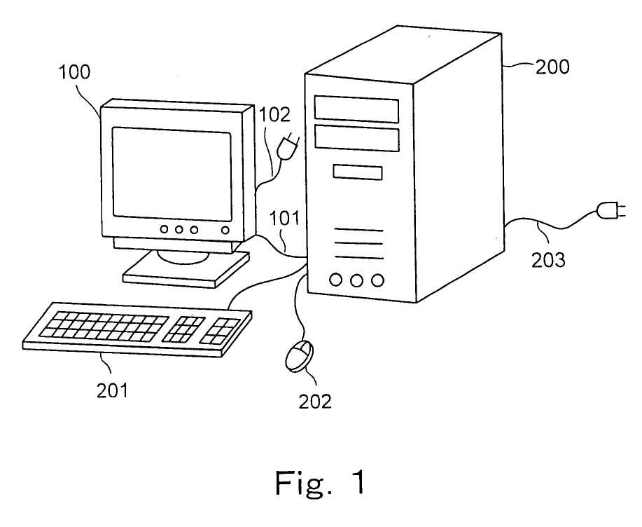

FIG. 1 is a schematic illustration of a computer system in which a display unit according to an embodiment of the present invention is connected.

As shown in FIG. 1, a display unit 100 is connected via a display cable 101 to a computer main frame 200 to perform an image display. An AC power source is supplied to the display unit 100 via an AC power source cable 102.

RGB signal (image signal) and HS signal and VS signal (horizontal synchronizing signal and vertical synchronizing signal) are fed from the computer main frame 200 via the display cable 101 to the display unit 100.

Connected to the computer main frame 200 are a keyboard 201 and a mouse 202 to transmit an instruction of an operator to the computer main frame 200, as well as the display unit 100. The AC power source is supplied to the computer main frame 200 via an AC power source cable 203.

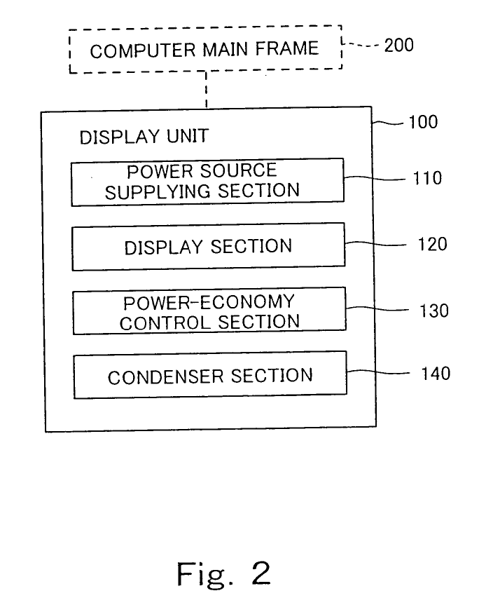

FIG. 2 is a schematic construction view of a display unit according to an embodiment of the present invention.

As shown in FIG. 2, the display unit 100 is connected to the computer main frame 200 to perform an image display, and comprises a power source supplying section 110, a display section 120, a power-economy control section 130 and an electrolytic condenser 140.

The power source supplying section 110 supplies a power source to the display unit 100. The display section 120 performs an image display in accordance with an image signal consisting of the RGB signal and the HS signal and the VS signal supplied from the computer main frame 200. The power-economy control section 130 controls a change over between a conducting mode wherein the power source supplying section 110 is in a turn-on state and a power economy mode wherein the power source supplying section 110 is in a turn-off state, in accordance with synchronizing signals included in the image signal. The electrolytic condenser 140 stores electric power of the synchronizing signals (HS and VS) supplied from the computer main frame 200, and makes at least the power-economy control section 130 to return to the turn-on state.

The electrolytic condenser 140 in the present embodiment corresponds to an example of the condenser section in the present invention, but the condenser section in the present invention is not restricted to only the electrolytic condenser, and any one is acceptable, as the condenser section in the present invention, which can store the electric power of the synchronizing signals.

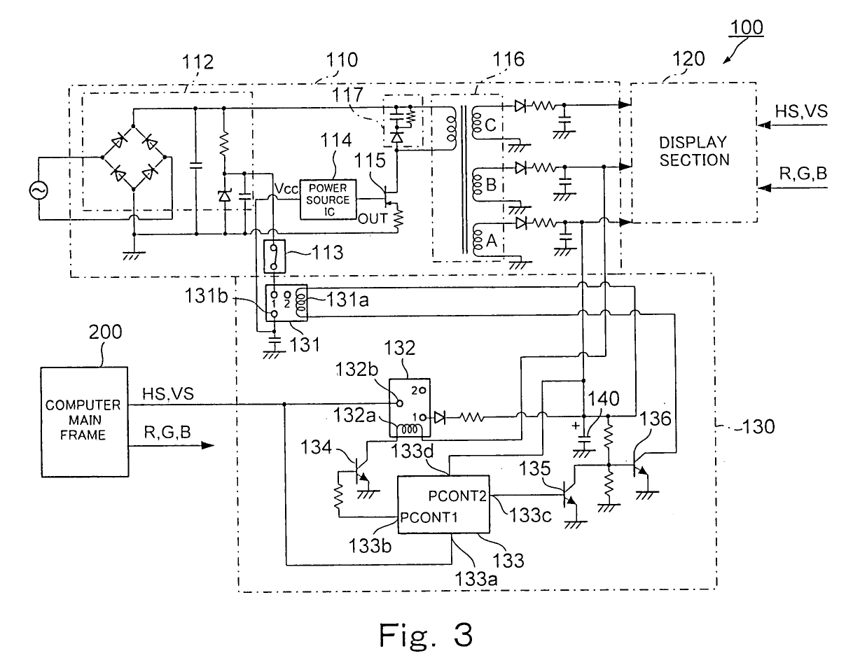

FIG. 3 is a circuit diagram of a power supplying circuit of a display unit according to an embodiment of the present invention.

As shown in FIG. 3, the display unit 100 is connected to the computer main frame 200 to perform an image display, and comprises the power source supplying section 110, the display section 120, the power-economy control section 130 and the electrolytic condenser 140.

The power source supplying section 110 supplies a power source to the display section 120 and the power-economy control section 130 of the display unit 100. The power source supplying section 110 comprises a rectifying and smoothing circuit 112, an external electric power switch 113, an electric power IC (Integrated Circuit) 114, an electric power FET (Field Effect Transistor) 115, an electric power transformer 116, and a snubber circuit 117.

The display section 120 performs an image display in accordance with the image signal supplied from the computer main frame 200. The display section 120 comprises an image display unit such as a CRT (cathode Ray Tube), a liquid display panel and a plasma display pane), and driving unit.

The power-economy control section 130 controls a change over between a conducting mode wherein the power source supplying section 110 is in a turn-on state and a power economy mode wherein the power source supplying section 110 is in a turn-off state, in accordance with synchronizing signals included in the image signal. The power-economy control section 130 comprises a first relay 131, a second relay 132, a microcomputer 133, a first transistor 134, a second transistor 135, and a third transistor 136.

The first relay 131 and the second relay 132 are provided with coil sections 131a and 132a and switch sections 131b and 132b, respectively.

The first relay 131 is set up in such a manner that when no current conducts through the coil section 131a, the switch section 131b is switched to a side 2, that is, offers a non-conductive state, and when current conducts through the coil section 131a, the switch section 131b is switched to a side 1, that is, offers a conductive state.

The second relay 132 is set up in such a manner that when no current conducts through the coil section 132a, the switch section 132b is switched to a side 1, that is, offers a conductive state, and when current conducts through the coil section 132a, the switch section 132b is switched to a side 2, that is, offers a non-conductive state.

According to the present embodiment, while there are used the relays, it is not restricted to the relays, and any one is acceptable, as those switching elements, which has the equivalent function to the above-mentioned relays.

The electrolytic condenser 140 stores electric power of the synchronizing signals supplied from the computer main frame 200, and makes the power-economy control section 130 to return to the turn-on state.

Hereinafter, there will be explained of the operation of the display unit 100.

Usually, the display unit 100 changes over to the power-economy mode in the event that at the time of the conducting mode, the use of the computer main frame 200 is temporally interrupted, and no synchronizing signal is transmitted from the computer main frame 200 to the display unit 100. At that time, in the event that there is a possibility that the display unit 100 changes over to the conducting mode, the external electric power switch 113 is set up to maintain turn-on state.

First, there will be explained a state of the display unit 100 at the time of the conducting mode.

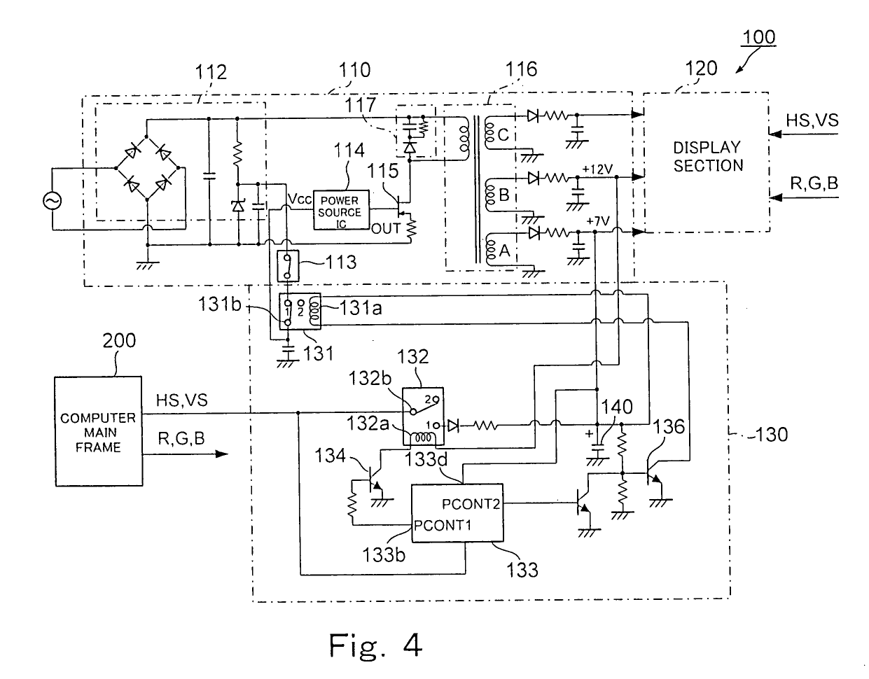

FIG. 4 is an explanatory view useful for understanding a state of a display unit according to an embodiment of the present invention at the time of a conducting mode.

As shown in FIG. 4, in the conducting mode, the power source supplying section 110 turns on. And thus the voltage of 7 volts is applied from a secondary coil A of the electric power transformer 116 to a terminal 133d of the microcomputer 133, so that the microcomputer 133 is in the operative condition. A control signal PCONT1 is outputted from the microcomputer 133, which is in the operative condition. The control signal PCONT1 makes the first transistor 134 to turn on, so that a current conducts from a secondary coil B of the electric power transformer 116 to the coil section 132a of the second relay 132. Thus, the switch section 132b is switched to the side 2 to offer a non-conductive state.

As a result, there is intercepted a supplying route of the synchronizing signal from the computer main frame 200 via the second relay 132 to the electrolytic condenser 140.

This state is maintained as far as the synchronizing signal is transmitted from the computer main frame 200, so that the conducting mode is maintained.

The power-economy control section 130 is so constructed that when it is returned to the turn-on state, a storage of the synchronizing signals by the condenser section (the electrolytic condenser 140) is stopped. However, it is not restricted to such an arrangement, it is acceptable to provide such an arrangement that the storage is maintained even after the return to the turn-on state. Nevertheless, in the turn-on state, it is preferable that a circuit for charge of the condenser section is intercepted, since the synchronizing signals can be used for the original use of the image display.

Next, there will be explained the change over from a conducting mode to a power-economy mode.

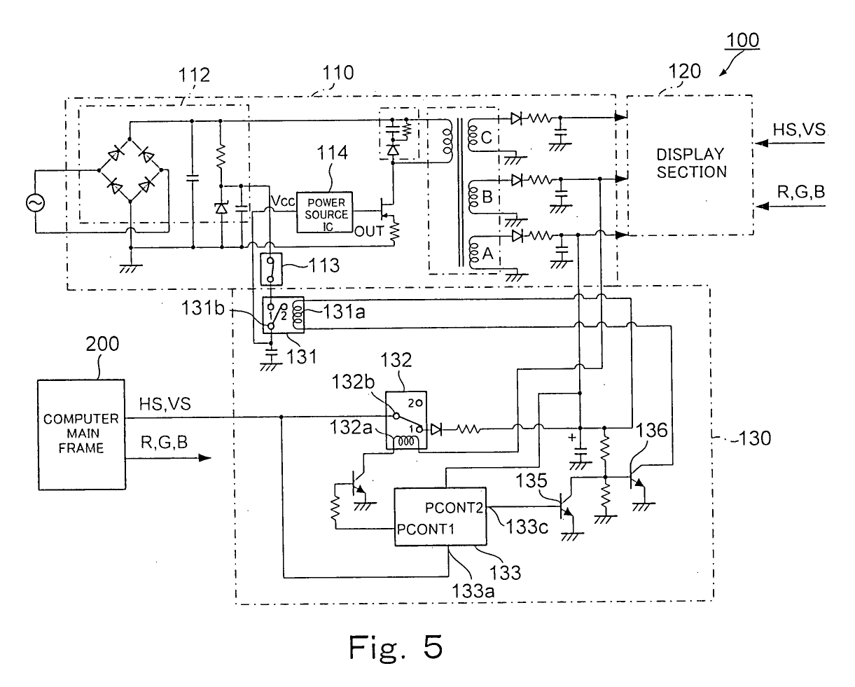

FIG. 5 is an explanatory view useful for understanding a state of a display unit according to an embodiment of the present invention after the display unit changes over in operation from a conducting mode to a power-economy mode.

The microcomputer 133 monitors whether an input of the synchronizing signals transmitted from the computer main frame 200 to a terminal 133a is continued. When no input of the synchronizing signals to the terminal 133a is detected, an output level of a control signal PCONT 2 from a terminal 133c offers HIGH (+5V), so that the second transistor 135 turns on.

As a result, the base voltage of the transistor 136 offers 0 volt and thus the transistor 136 turns off, so that a current to the coil section 131a of the first relay 131 is intercepted. Thus, the switch section 131b is switched to the side 2 to offer a non-conductive state.

Accordingly, the currents from the rectifying and smoothing circuit 112, and the external electric power switch 113 are not supplied to the electric power IC 114, so that the power source supplying section 110 turns off. Thus, the power source supplying section 110 does not supply a current to the power-economy control section 130, and the display section 120 and the power-economy control section 130 are completely stopped in their operation. Therefore, the dissipation power of the display unit 100 becomes zero.

Since the power source supplying section 110 turns off, a current supply from the secondary coil B of the electric power transformer 116 to the coil section 132a of the second relay 132 is stopped, and the switch section 132b is switched to the side 1 to offer the conductive state.

Next, there will be explained an operation of the respective sections of a display unit according to the present embodiment when the display unit returns from the power-economy mode to the conducting mode.

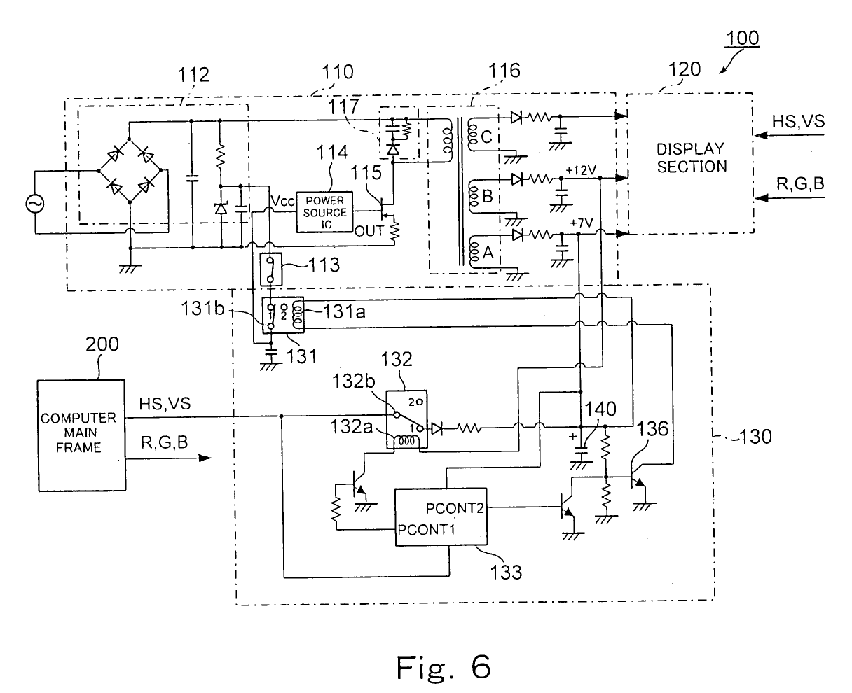

FIG. 6 is an explanatory view useful for understanding an operation of the respective sections of a display unit according to an embodiment of the present invention when the display unit returns from the power-economy mode to the conducting mode.

The display unit 100 according to the present embodiment is so arranged that when the display unit 100 receives the synchronizing signals (HS and VS signals) of 5 volts usually transmitted from the computer main frame 200, and returns from the power-economy mode to the conducting mode. That is, as shown in FIG. 6, when the synchronizing signals (HS and VS signals) transmitted from the computer main frame 200 is fed to the relay 132 of the power-economy control section 130, the return operation to the conducting mode starts.

At the time point, since the power source supplying section 110 turns off, the power source supplying section 110 does not supply a current to the coil section 132a of the second relay 132. As mentioned above, when the current conducts through the coil section 132a of the second relay 132, the switch section 132b is switched to the side 1 to offer the conductive state. Accordingly, the synchronizing signals transmitted from the computer main frame 200 are charged via the relay 132 onto the electrolytic condenser 140.

When the current of the synchronizing signals is charged onto the electrolytic condenser 140 so that the voltage of the electrolytic condenser 140 rises, and the base voltage of the third transistor 136 reaches 0.7V or more, the third transistor 136 turns on. As a result, the current charged on the electrolytic condenser 140 conducts through the coil section 131a of the first relay 131, and thus the switch section 131b is switched to the side 1 to offer the conductive state.

As a result, the voltages from the rectifying and smoothing circuit 112, and the external electric power switch 113 are supplied via the first relay 131 to a terminal VCC of the electric power IC 114, so that a wave is outputted from an output terminal OUT of the electric power IC 114. The output wave causes the electric power FET 115 to oscillate, so that the electric power transformer 116 operates to turn on the power source supplying section 110.

It is sufficient for an amount of electric power to be charged onto the electrolytic condenser 140 to provide an amount capable of holding the relay 131 to be conductive about 1 second to 2 seconds.

Thus, when the power source supplying section 110 turns on, for example, 7V, 12V, and other voltage are supplied from the respective coils of the secondary side of the electric power transformer 116 to the display section 120, so that the display section 120 displays an image.

Here, since the voltage of +7V, which is outputted from the secondary coil A of the electric power transformer 116 and is rectified, is charged onto the electrolytic condenser 140 of the power-economy control section 130, the voltage of the electrolytic condenser 140 maintains the turn-on state of the third transistor 136 and the conductive state of the relay 131, and thus the conductive mode is continued.

Next, there will be explained a power-economy controller according to an embodiment of the present invention.

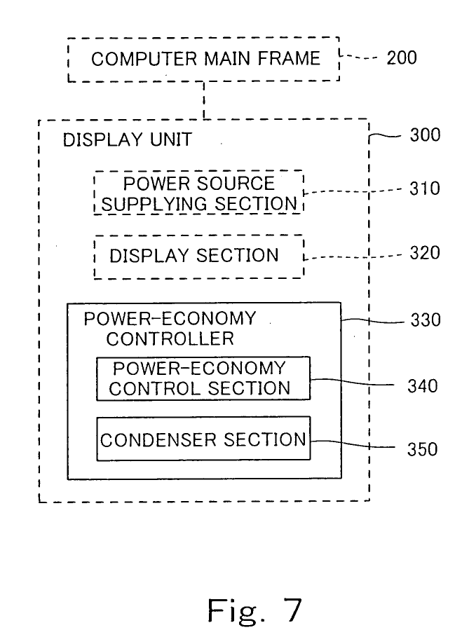

FIG. 7 is a schematic construction view of a power-economy controller according to an embodiment of the present invention.

A shown in FIG. 7, a power-economy controller 330 comprises a power-economy control section 340 for controlling a change over between the conductive mode and the power-economy mode in accordance with the synchronizing signals included in the image signal, and a condenser section 350 for storing electric power of the synchronizing signals to return at least the power-economy control section 340 to the turn-on state. The power-economy controller 330 is used in a display unit 300 having a display section 320 for performing an image display in accordance with the image signal fed from the computer main frame 200, and a power source supplying section 310 for supplying a power source. The power-economy controller 330 controls a change over between the conducting mode in which the power source supplying section 310 is in a turn-on state and the power-economy in which the power source supplying section 310 is in a turn-off state.

The structure and the functional effect of the power-economy control section 340 and the condenser section 350 in the power-economy controller 330 are the same as those of the power-economy control section 130 and the condenser section (the electrolytic condenser 140) in the display unit 100 explained referring to FIG. 2 to FIG. 6. And thus redundant description will be omitted.

As mentioned above, according to the display unit of the present invention, the display unit has the power-economy control section for controlling a change over between the conductive mode and the power-economy mode in accordance with the synchronizing signals included in the image signal supplied from the computer main frame, and the condenser section for storing electric power of the synchronizing signals supplied from the computer main frame to return the power-economy control section to the turn-on state. This feature makes it possible to implement a display unit capable of further reducing the dissipation power at the time of the power-economy mode.

In the event that the power-economy control section of the display unit of the present invention is constructed in such a way that at the time of return to the turn-on state the condenser section stops the storage of the synchronizing signals, a circuit for charging in the condenser section, which is unnecessary in the turn-on state, is intercepted, and thus it is possible to prevent malfunction of the power-economy control section.

According to the power-economy controller of the present invention, the power-economy controller in the display unit has the power-economy control section for controlling a change over between the conductive mode and the power-economy mode in accordance with the synchronizing signals included in the image signal supplied from the computer main frame, and the condenser section for storing electric power of the synchronizing signals supplied from the computer main frame to return the power-economy control section to the turn-on state. This feature makes it possible to implement a power-economy controller capable of further reducing the dissipation power at the time of the power-economy mode.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A display unit comprising:
a display section that performs an image display in accordance with an image signal;
a power source supplying section that supplies a power source to the display unit;
a power-economy control section that controls a change over between a conducting mode wherein the power source supplying section supplies the power source and a power-economy wherein the power source supplying section stops a supply of the power source, in accordance with synchronizing signals included in the image signal; and
a condenser section that stores electric power of the synchronizing signals and makes the power-economy control section to return to a conductive state.

2. A display unit according to claim 1, wherein the power-economy control section stops storage of electric power of the synchronizing signals by the condenser section when the power-economy control section returns to the conductive state.

3. A power-economy controller used in a display unit having a display section that performs an image display in accordance with an image signal, and a power source supplying section that supplies a power source, the power-economy controller comprising:
a power-economy control section that controls a change over of an operating state of the power source supplying section in accordance with synchronizing signals included in the image signal; and
a condenser section that stores electric power of the synchronizing signals and makes the power-economy control section to return to a conductive state.

4. A power-economy controller according to claim 3, wherein the power-economy control section stops storage of electric power of the synchronizing signals by the condenser section when the power-economy control section returns to the conductive state.
